(19) United States
(12) Patent Application Publication
(10) Pub. No.: US 2005/0125622 A1
(43) Pub. Date: Jun. 9, 2005

(54) MEMORY DEVICE CAPABLE OF SUPPORTING SEQUENTIAL MULTIPLE-BYTE READING

(76) Inventors: Chao-Ping Chuang, Tai-Chung City (TW); Jen-Chin Chan, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/709,792

(22) Filed: May 28, 2004

(30) Foreign Application Priority Data
Dec. 5, 2003 (TW) 092134472

(51) Int. Cl. G06F 12/04

(52) U.S. Cl. 711/200

(57) ABSTRACT

When the memory device receives address information and byte information M, the memory device continuously provides M bytes corresponding to M addresses following an address assigned in the address information. The memory device includes: an address calculation module, an address buffer, a decoding module, a plurality of memory units and output buffers. Each output buffer is capable of receiving data of two units and sequentially outputting the data. When the address calculation module stores an address in the address buffer, the decoding module makes cells corresponding to the address simultaneously output data to the output buffers, such that the output buffers sequentially output data of respective unit. The address calculation module starts to count the next address, such that when the output buffer finishes outputting, the next address is already stored in the address buffer, and the decoding module has already made units corresponding to the next address output data.

### BACKGROUND OF INVENTION

1. Field of the Invention

The present invention relates to a memory device (such as a flash memory) for supporting sequential multiple-byte reading, and more particularly, a memory device for sequentially reading by an address buffer and an output buffer.

2. Description of the Prior Art

In prior art microprocessors and computer systems, circuit configurations with different functions are necessary to realize the complex and various functions of the microprocessor or computer system. How to exchange electric signals and data efficiently among different circuit configurations to complete proper functions of a computer system is a key development issue of modern information companies. Moreover, development points of modern computer systems should consider low power dissipation, low cost, and small area, so that related developments become more complicated.

Please refer to FIG. 1 illustrating a schematic function diagram of a prior art computer system 10, which includes a central processing unit 12, a volatile memory 18 and a chipset 14 (such as north and south bridge chipset) connected to a memory device 20 and a peripheral controller 22A through a bus 16. The central processing unit 12 maintains operations of the computer system 10; the memory 18 registers data and programs for operations of the central processing unit 12; the memory device 20 can be a non-volatile memory device, such as flash memory, which supports the computer system 10. For example, the memory device 20 can be a basic input/output system (or BIOS) of a flash memory to store programs for starting the computer system 10 (such as a variety of check processes and operation arguments). The peripheral controller 22A controls a peripheral device 22B (such as input device: keyboard or mouse). The memory device 20 and the peripheral controller 22A connected to the chipset 14 and the bus 16 can exchange data with the central processing unit 12 to achieve the functionality of the computer system 10.

As FIG. 1 illustrated, the bus 16 is a significant data channel among the chipset 14, the memory device 20 and other devices. In modern computer systems, fewer wires are expected to be used to construct the bus 16. The fewer the wires of the bus 16, the fewer the pins of the chipset 14, the memory device 20, and the peripheral controller 22A. Therefore, areas and power dissipations of the chipset 14 and the memory device 20 are reduced efficiently. For example, the information company Intel sets up a low-pin count (or LPC) bus standard, which is a bus protocol for exchanging data through a LPC bus.

Please refer to FIG. 2 (and FIG. 1) illustrating a schematic diagram of an LPC bus 16, which includes six wires: line CLK and lines FWH0 to FWH4. The chipset 14 seen as a host end by the bus 16 transmits time pulsations to the memory device 20 (device end) through the line CLK to control the data exchange timing clock of the host end and the device end. Moreover, the host end can also trigger starts and ends of data exchanges through the line FWH4. Data exchange between the host end and the device end is mainly through the lines FWH0 to FWH3 (noted as FWH[3:0] in FIG. 2).

Although an LPC bus can reduce pins in the host end and the device end, data must be transmitted serially for exchange (especially much larger size data). Transmitting a series of data sequentially can therefore increase efficiency. The above-mentioned LPC bus standard sets up a sequential multiple-byte reading protocol, so as to read the memory device faster. Please refer to FIG. 3 (also FIG. 1 and FIG. 2) illustrating a schematic diagram of a data exchange protocol in signal versus time domain when the host and the device ends continuously exchange data through the bus 16 in FIG. 2. The X-axis in FIG. 3 is time, and the Y-axis shows data exchange situations among the lines. When the device end is the memory device 20, the host end and the device end follow time sequences shown in FIG. 3 to read data requested by the host end from the memory device 20, and then to transmit the data back to the host end (or the chipset 14).

As illustrated in FIG. 3, at time point t0, the host end initially pulls signal of the line FWH4 from high to low level to indicate a start of data exchange through the bus 16. At time point t1 (or the rising side of the line CLK in time domain), the host end triggers a four-bit signal START (each line triggers a one-bit signal and lasts a time cycle T) through the lines FWH0 to FWH3 to appoint a target (here it should be the memory device 20) for data exchanges and operations (reading from the memory device 20), so that it can start the data exchange process between the host end and the memory device 20.

At time point t2, the host end similarly triggers a four-bit signal IDSEL through the lines FWH0 to FWH3 to represent that the host end demands to read data from some part of the memory device 20. Each data stored in the memory device 20 has a corresponding address. Then, between time points t3 and t4, the host end triggers a twenty-eight-bit signal MADDR to appoint data addresses of the demanded data through the lines FWH0 to FWH3 in seven cycles of T. Each one of the lines FWH0 to FWH3 can transmit one bit in one cycle T, so that four lines can transmit a twenty-eight-bit address to the memory device 20 in the device end in seven cycles. Afterward, the host end transmits a four-bit signal MSIZE to the device end at time point t4 to represent data numbers for continuously reading. In FIG. 3, if the address of the signal MADDR is AR(X) and the signal MSIZE is four (the host end demands four data), the host end will read four bytes corresponding to AR(X), AR(X+1), AR(X+2), and AR(X+3) from the memory device 20. In other words, according to the initial address provided by the host end signal MADDR and the data number provided by the signal MSIZE, the device-end memory device 20 should be capable of calculating each demanded data address by progressively increasing address.

Between time points t5 and t6 is a two-cycle signal TAR (or turn-around cycle) to represent that the bus 16 controlled by the memory device 20 starts to transmit demanded data from the memory device 20 to the host end. At time point t6, the memory device 20 triggers a four-bit signal SYNC through the lines FWH0 to FWH3 to represent that the memory device 20 starts to control the data transmission. In order to realize high-speed data transmission, the memory device 20 should be capable of continuously transmitting four demanded data subsequently. The memory device 20 transmits one byte (eight bits), or signal DATA1, corresponding to the address AR(X) in two cycles between time points t7 and t8. Then, it transmits one byte, or signal DATA2, corresponding to the address AR(X+1). Therefore, the memory device 20 transmits four bytes (or signals DATA1 to DATA4) corresponding to the addresses AR(X) to AR(X+3) sequentially to match the host end demand in the time points t1 to t5. After time point t11, a two-cycle signal TAR reappears to complete data exchanges with the host end.

As mentioned above, in order to match the bus 16 with fewer wires, the memory device 20 in the device end should be able to calculate addresses continuously by progressively increasing (or decreasing) addresses such as in the time domain diagram shown in FIG. 3, and then to transmit multiple bytes sequentially, so that it can support high efficiency data reading protocols (or sequential multiple-byte reading). However, in general, makers of prior art memory devices find it difficult to support the above-mentioned protocol. Furthermore, please refer to FIG. 4 illustrating a block diagram of a prior art memory device 30. The memory device 30 can be a flash memory, which includes an interface circuit 24, a control circuit 26, an address calculation module 28, a decoding module 32, a memory matrix 36, and a plurality of sensor circuits 40. The interface circuit 24 connected to the bus 16 receives signals through the lines CLK, FWH0 to FWH4 to exchange data with a host end (not shown in FIG. 4). The control circuit 26 controls operations of the memory device 30, and the address calculation module 28 calculates addresses to output them as signal ADDRp. In the memory matrix 36, there are a plurality of memory units 38 each capable of recording one bit (for example, to record data in a non-volatile manner in a floating gate transistor). Besides, there are a row decoder 34 and a column decoder 34B in the decoding module 32 to decode addresses corresponding to each memory unit 38 according to the address signal ADDRp provided by the address calculation module 28, and to make these memory units 38 each corresponding to the memory matrix 36 to transmit data to each sensor circuit 40.

To match the lines FWH0 to FWH6 of the bus 16, the memory device 30 also includes four sensor circuits 40 each capable of sensing, testing, and reading data provided by a memory unit 38, and transmitting the data to a corresponding line. As FIG. 4 illustrates, basic structures in each sensor circuit 40 are the same, wherein a sensor amplifier 42, an inverter I, and an output stage are made by complementary metal oxide semiconductors (or CMOS). Data from a memory unit 36 is transmitted to the sensor circuit 40, and is compared with a reference voltage Vr in the sensor amplifier 42 to decide which data, null or one, should be stored in the memory unit. Moreover, a corresponding signal SAOUTp provided by the inverter I and the CMOS bias in Vd and G is transmitted to the interface circuit 24 in order to transmit one bit to a corresponding line (one of the lines FWH0 to FWH3).

Nevertheless, a bottleneck exists when realizing the sequential multiple-byte reading protocol in FIG. 3 with the prior art memory device 30. Please refer to FIG. 5 (and FIG. 4) illustrating a schematic diagram of the memory device 30 in FIG. 4 when reading data in the time domain. In FIG. 5, the X-axis is time-scale, and time sequences of the sequential multiple-byte reading protocol are also shown in comparison with FIG. 3. According to the protocol, the host end triggers a twenty-eight-bit signal MADDR as the initial address AR(X) in seven cycles T between t2 and t4. Triggered by a rising edge in the time domain, the memory device 30 should receive the twenty-eight-bit signal MADDR at time point t3b through the interface circuit 24 and the control circuit 26, and then transmit signal MADDR to the address calculation module 28, and also the address AR(X) of the signal ADDRp after time point t3b. According to the protocol, the memory device 30 starts to provide data corresponding to the first four addresses of the AR(X) at time point t7, so that the decoding module 32 can decode addresses within time points t3b to t6, and four memory units corresponding to the first four addresses of the AR(X) start to transmit their stored bits to four sensor modules 40 at time point t6 respectively. At time point t7, each sensor module 40 completes data sensing and outputs its read bit, a one-bit data Px of the signal SAOUTp. Combining four one-bit data provided by the four sensor modules 40 can return the first four addresses of the AR(X) at time point t7, which fits the protocol in time domain.

According to regulations of the protocol, the prior art memory device 30 should continue to transmit a later four addresses of the AR(X) at time point t7p. However, there are some problems in the prior art memory device 30 in that the prior art memory device 30 needs to delay a time slot Tp1 to continue reading the later four addresses, which requires re-decoding memory units corresponding to the later four addresses of the AR(X), resetting each sensor module 40, and sensing each one-bit data Qx stored in the four memory units. Therefore, the prior art memory device 30 may wait until time point t8 to provide the later four addresses. In this way, the sequential multiple-byte reading cannot be realized.

In addition, in the process of sequential multiple-byte reading, calculating addresses is another problem of the prior art memory device 30. As mentioned above, after dealing with the address AR(X), the memory device 30 should be able to transmit data of the next address AR(X+1) sequentially. As FIG. 5 illustrates, since the decoding module 32 decodes the memory units corresponding to the later four addresses of the AR(X) at time point t7p, the address calculation module 28 starts to calculate the next address AR(X+1) by progressively increasing the address AR(X) at time point t8. In order to calculate the address AR(X+1), the address calculation module 28 needs another time slot Tp2. As discussed above, the bit size of the addresses AR(X) and AR(X+1) is twenty eight, so that even if an address only increases by one, calculating addresses still demands a lot of time. Therefore, the address calculation module 28 starts to calculate the next address AR(X+1) at time point t8p. Afterward, according to the address AR(X+1), the decoding module 32 makes the sensor module 40 start to sense and test the corresponding four memory units at time point t9 to provide the first four addresses of the AR(X) (also the data Px1 of the signal SAOUTp). As FIG. 5 illustrates, because time for calculating addresses directly affects time sequences of the data sensor, the prior art memory device 30 cannot continue dealing with data corresponding to the address AR(X+1) after finishing the transmission of the data corresponding to the address AR(X). Therefore, the sequential multiple-byte reading protocol cannot be realized.

In summary, the prior art memory device 30 cannot support the sequential multiple-byte reading protocol. This reduces data exchange efficiency, and affects functions of a computer system.

### SUMMARY OF INVENTION

It is therefore a primary objective of the claimed invention to provide a memory device that can support sequential multiple-byte reading.

According to the claimed invention, a memory device includes a plurality of memory units each corresponding to an address, an interface circuit, an address calculation module, an address buffer, and a decoding module.

The interface circuit receives address information. The address calculation module connected to the interface circuit provides a first address according to the address information. The address buffer connected to the address calculation module receives and stores addresses provided by the address calculation module, wherein the address calculation module can generate and provide a second address different from the first address according to the address information after the address buffer stores the first address.

The decoding module connected to the address buffer enables each memory unit corresponding to the first address to output its data when the address buffer stores the first address, and the address calculation module can provide the second address. After each memory unit corresponding to the first address outputs its data, the address buffer can store the second address provided by the address calculation module, and the decoding module can enable each memory unit corresponding to the second address to output its data.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a block diagram of a prior art computer system.

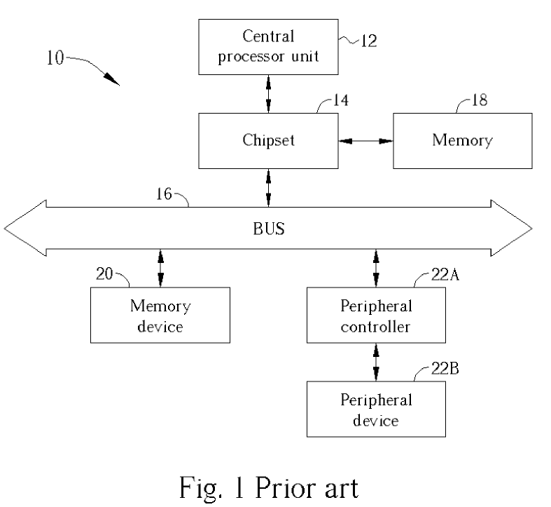

FIG. 2 illustrates a schematic diagram of bus connection between the chipset and the memory device in FIG. 1.

FIG. 3 illustrates a time sequences diagram of data exchange protocol when the chipsets reads multiple bytes sequentially from the memory device in FIG. 2.

FIG. 4 is a block diagram of a prior art memory device.

FIG. 5 illustrates a time sequences diagram of the memory device in FIG. 4 when reading data.

FIG. 6 illustrates a block diagram of the present invention.

FIG. 7 illustrates a circuit configuration diagram of the output buffer in FIG. 6.

FIG. 8 illustrates a related signal waveform diagram of the memory device in FIG. 6 during operation.

### DETAILED DESCRIPTION

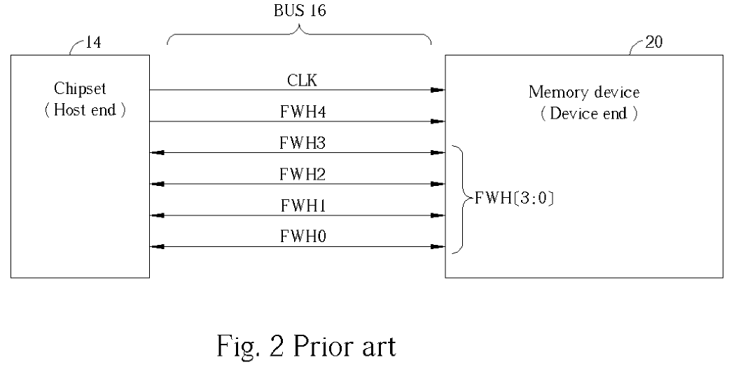

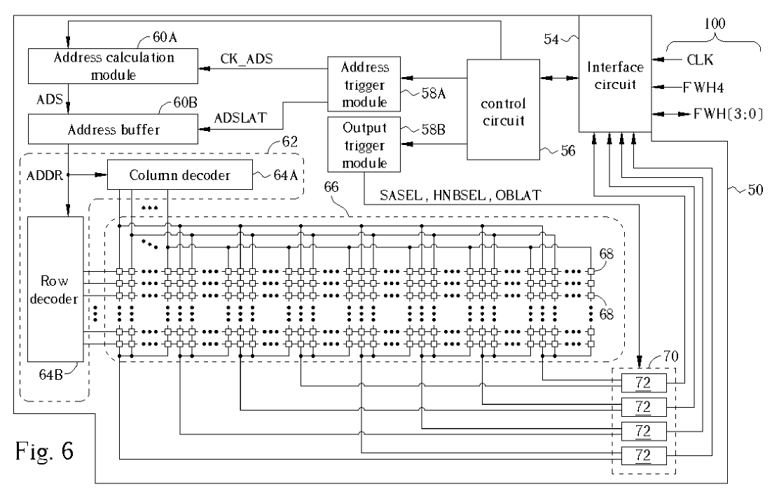

Please refer to FIG. 6. FIG. 6 illustrates a block diagram of a present invention memory device 50. The memory device of the present invention can be a flash memory (such as a basic input/output system flash memory in a computer system), and includes an interface circuit 54, a control circuit 56, an address trigger module 58A, an output trigger module 58B, an address calculation module 60A, an address buffer 60B, a decoding module 62, a memory matrix 66, and a sensor module 70. The interface circuit 54 exchanges data with a host end (such as the chipset in FIG. 2, not shown in FIG. 6) through lines CLK, FWH0-FWH4 of a bus 100. The control circuit 56 controls operations of the memory device 50. When processing sequential multiple-byte reading, the address trigger module 58A controls the address calculation module 60A with the signal CK_ADS, which can trigger the address calculation module 60A to calculate each address by progressively increasing addresses, and to output the signal ADS. Besides, the address trigger module 58A can also trigger the address buffer 60B to receive addresses from the address calculation module 60A with the signal ADSLAT and then to store (latch) the addresses, so that it can transmit the addresses to the decoding module 62 with the signal ADDR.

The memory matrix 66 includes a plurality of memory units 68 arranged in a matrix, each memory unit 68 storing one bit of data. For example, the memory unit 68 can include floating gate transistors to store data in a non-volatile manner. The decoding module 62 includes a column decoder 64A and a row decoder 64 corresponding to the memory matrix 66. According to addresses stored in the address buffer 60B, the decoding module 62 can make each memory unit 68 corresponding to the addresses outputting its one-bit data. In the following example, an address stored in the address buffer 60B corresponds to one byte. In other words, eight memory units 68 correspond to the address. In the present invention, the decoding module 62 decodes eight memory units corresponding to an address, and makes the eight memory units output their one-bit data at same time. Concerning the eight memory units, the sensor module 70 of the present invention further includes four output buffers 72 each capable of receiving data from two memory units. The output trigger module 58B can trigger controls of each output buffer 58B with signals SASEL, HNBSEL, and OBLAT, so that the output buffer 58B transmits data of two memory units to an interface circuit in two cycles one by one for the memory device 50.

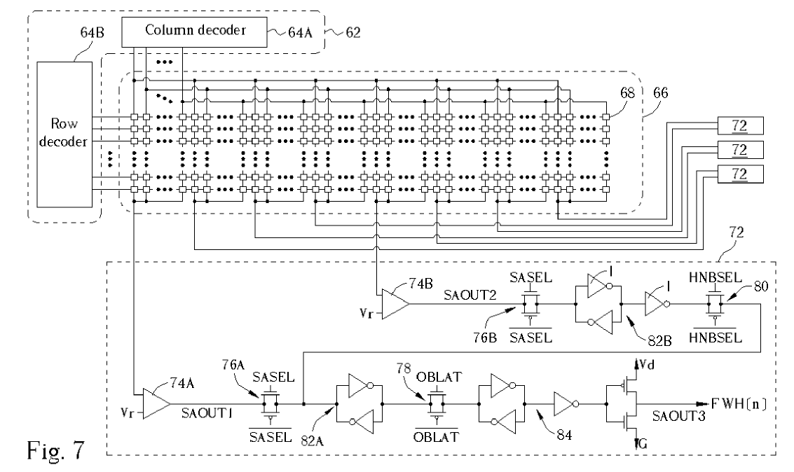

Please refer to FIG. 7 (also FIG. 6). The structure of each output buffer 72 is identical. FIG. 7 illustrates a schematic diagram of an output buffer 72 of the present invention (and also illustrates interconnections of the output buffer and the memory matrix 66). The output buffer 72 of the present invention includes two sensor amplifiers 74A and 74B, four complementary metal oxide semiconductor (CMOS) transmission gates 76A, 76B, 78, 80, three latch circuits 82A, 82B, 84 each comprising a combination of inverters I, and an output stage bias between voltages Vd and G (also CMOS). The two sensor amplifiers 74A and 74B sense and test data provided by a memory unit, and output corresponding signals SAOUT1 and SAOUT2 respectively. Each transmission gate is a transmission circuit, wherein the transmission gates 76A and 76B are controlled by the signal SASEL (and its inverse signal), and the transmission gates 78 and 80 are controlled respectively by signals OBLAT and HNBSEL (and their corresponding inverse signals). Finally, a signal SAOUT3 of the output stage can be an output of a line FWH[n] (n is 0 to 3 to match four output buffer circuits 72) to output data provided by the memory device 50.

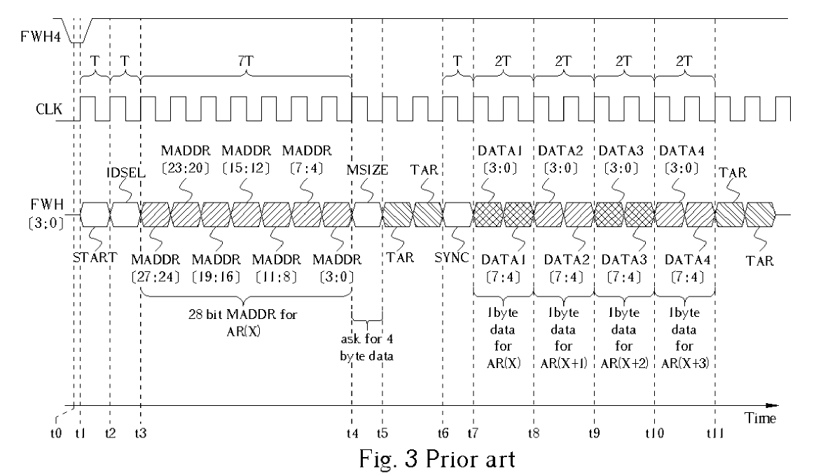

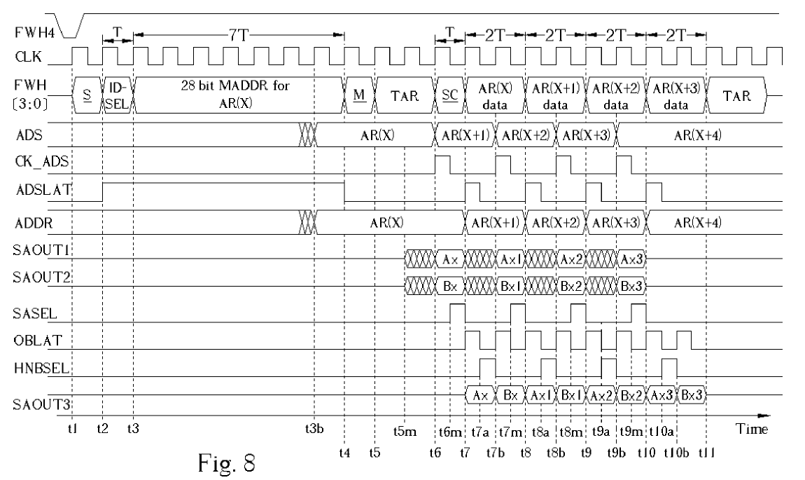

Please refer to FIG. 8 (also FIG. 3, FIG. 6, and FIG. 7). Concerning operations of the memory device 50, FIG. 8 is a time sequence diagram of each related signal when the memory device 50 performs the sequential multiple-byte reading in FIG. 3. The X-axis of FIG. 8 is time. As mentioned above with reference to FIG. 3, in the sequential multiple-byte reading protocol, the host end transmits signals START (noted as “S” in FIG. 8) and IDSEL at time points t0 and t2 respectively through the line FWH[3:0] of the bus, so that the control circuit 56 of the memory device 50 is ready to read data. Among seven cycles of T within time points t3 and t4, the host end transmits its demanded initial address (or the address AR(X)) with a twenty-eight-bit signal MADDR, and byte numbers for sequential reading with a signal MSIZE (noted as “M” in FIG. 8) to the memory device 50. Similar to FIG. 3, in the implementation in FIG. 8 it is also assumed that the host end demands a series of four bytes. After a two-cycle signal TAR and a one-cycle signal SYNC (noted as SC in FIG. 8), the memory device 50, at time point t7, starts sequentially providing four bytes corresponding to the address AR(X) to AR(X+3) to the host end among the next eight cycles T.

As illustrated in FIG. 8, when triggering is by rising edge, the memory device 50 can receive all twenty-eight bits of the signal MADD at time point t3b, so that both the address calculation module 60A and the address buffer 60B can receive the address AR(X) at time point t3b. Owing to still five cycles T from time points tb3 to t7 for starting transmission, the decoding module 62 of the memory device 50 has enough time to decode, and, at time point t5m, makes eight memory units corresponding to the address AR(X) transmitting their data to corresponding output buffers at the same time. As illustrated in FIG. 8 (and FIG. 7), in each output buffer 72, signals SAOUT1 and SAOUT2 represent that both of their corresponding sensor amplifiers 74A and 74B start to sense and test data provided by corresponding memory units at time point t5m, and read the data steadily at time point t6 (or one-bit data Ax and Bx). Combining eight bits provided by four output buffers 72, or eight sensor amplifiers, yields a byte corresponding to the address AR(X).

Following that, at time point t6m, the output trigger module 58B starts pulling the signal SASEL from low to high level to open the closed transmission gates 76A and 76B, and storing (latching) data provided by the sensor amplifiers 74A and 74B in the latch circuits 82A and 82B. According to the sequential multiple-byte reading protocol, at time point t7, the memory device 50 should output the first four bits corresponding to the address AR(X). Therefore, at time point t7, the output trigger module 58B of the present invention raises the level of the signal OBLAT to open the transmission gate 78, then transmits data stored in the latch circuit 82A (or the data Ax) to the latch circuit 84, and outputs the data through the output stage. Combining four one-bit data provided by four output buffers at time point t7 finishes transmitting the first four bits corresponding to the address AR(X) to the host end.

The following signal OBLAT controls opening of the transmission gate 78 between time points t7 and t7a. The output trigger module 58B pulls the signal HNBSEL high between time points t7a and t7b to open the transmission gate 80, and transmits data stored in the latch circuit 82B (or the data Bx) to the latch circuit 82A. Between time points t7a and t7b, the data Ax stored in the latch circuit 82A originally has be stored in the latch circuit 84 (opened by the signal OBLAT), so that the data Bx stored in the latch circuit 82B can be shifted to the latch circuit 82A. At time point t7b, the signal OBSLAT returns to the high level to open the transmission gate 78, and then the data Bx stored in the latch circuit 82B can be transmitted to the latch circuit 84 for output. Combining four bits provided by the output buffer 72 at time point t7b fits the protocol in that the next four bits corresponding to the address AR(X) output at time point t7b sequentially.

In other words, the present invention reads eight bits of one byte corresponding to an address at the same time, and outputs the eight bits with operations of each output buffer 72 in two cycles T respectively, so as to meet the sequential multiple-byte reading protocol. In comparison, the prior art memory device 30 mentioned above can only read four bits at the same time, which requires it to divide a byte into four bits so that it demands a delay time slot for re-sensing when transmitting the four bits. Thus, the memory device 30 cannot fit the sequential multiple-byte reading protocol.

On the other hand, according to the sequential multiple-byte reading protocol, after transmitting a byte of the address AR(X) in two cycles of T between time points t7 and t8, a byte corresponding to the next address AR(X+1) is transmitted at time point t8 continuously. As FIG. 8 illustrates, after the address calculation module 60A transmits the address AR(X) to the address buffer 60B, the address trigger module 58A pulls the signal CK_ADS from low to high at time point t6, so as to trigger the address calculation module 60A to calculate the next address AR(X+1). Meanwhile, the signal ADSLAT, which controls the address buffer 60B, remains low to latch its stored address AR(X), so that the address AR(X) does not change while the signal ADS changes (the address buffer 60B can be achieved by a data latch). Therefore, when the decoding circuit starts to decode eight memory units corresponding to the address AR(X) provided by the address buffer 60B at time point t5m, the signal ADS does not affect this process. Please note that when the address calculation module 60A starts calculating the next address AR(X+1) at time point t6, the eight-bit data corresponding to the address AR(X) has just finished being sensed/read, or has not yet even been transmitted to the host end.

At time point t7, the address calculation module 60A has a cycle T to finish calculating the address AR(X+1). At the same time, the address trigger module 58A pulls the signal ADSLAT to the high level to trigger the address buffer 60B receiving the address AR(X+1) provided by the address calculation module 60A. Meanwhile, at time point t7, the decoding module 62 can start decoding eight memory units corresponding to the address AR(X+1), transmitting data stored in these memory units to each output buffer 72, and then detecting each byte corresponding to the address AR(X+1) from each sensor amplifier of the output buffer 72. At time point t7b, each sensor amplifier can steadily output each bit corresponding to the address AR(X+1), which is data Ax1 and Bx1 noted in the signals SAOUT1 and SAOUT2. Owing to the still low level of the signal SASEL between time points t7b and t7m, the transmission gates 76A and 76B are maintained closed, so that each output buffer 72 continuously outputs the later four bits data of the address AR(X) from the latch circuit 84. At time point t7m, the signal SASEL is pulled to a high level again to transmit each bit of the AR(X+1) from the sensor amplifier to the latch circuits 82A and 82B. Then, at time point t8, the signal OBLAT is transferred to high to enable the four output buffers 72 to output the first four bits data of the address AR(X+1) (or each one-bit data Ax1 provided by each output buffer 72) from the latch circuit 84, so that the sequential multiple-byte reading protocol is realized.

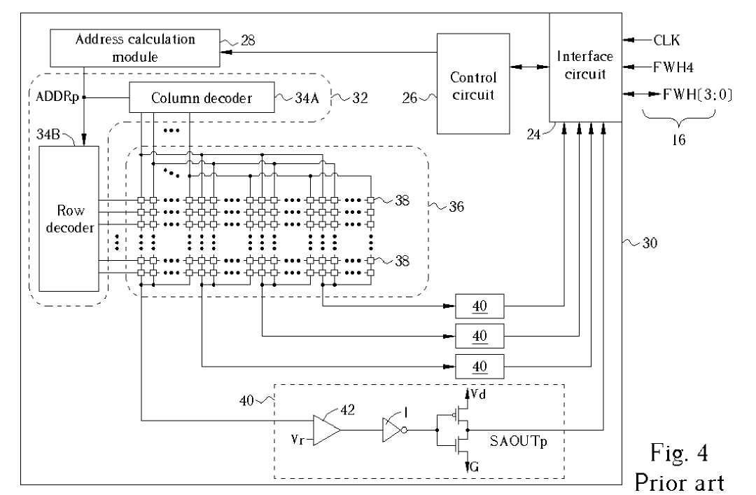

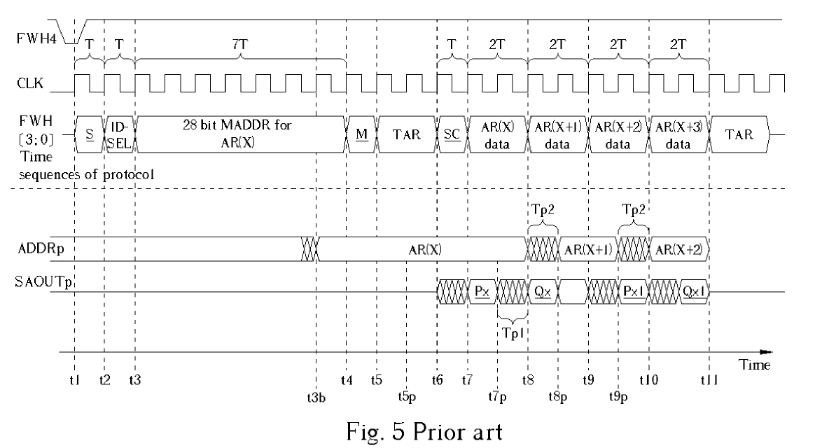

As mentioned above, the present invention locks addresses of the decoding module 62 by the address buffer 60B to make the address calculation module 60A to calculate next address directly, so that processes of decoding and addresses calculation can occur at the same time. As illustrated in FIG. 8, when each sensor amplifier of the output buffer deals with data reading of the address AR(X) from time points t5m, t6 to t7, the address calculation module 60A calculates the next address AR(X+1) at time point t6, and provides the calculated address AR(X+1) at time point t7. Following that, the decoding module 62 and each sensor amplifier can sense and test data corresponding to the address AR(X+1) from time points t7, t7b to t8. Meanwhile, at time point t7b, the address calculation module 60A can start to calculate the next address AR(X+2). As the decoding module 62 and each sensor amplifier finish data sensing/reading of the former address, the address calculation module 60A just finishes calculating the next address, so that the decoding module 62 and each sensor amplifier can continuously sense and test next addresses, and data sensing of different addresses can be performed sequentially. This is illustrated in the diagrams of the signals SAOUT1 and SAOUT2 in FIG. 8. In comparison, when the prior art memory device shown in FIG. 4 and FIG. 5 deals with data sensing of different addresses, delays and breaks comes out for address calculations. Owing to cooperation within the address calculation module 60A and the address buffer 60B, as well as design of two-bit reading and sequential outputting in each output buffer 72, the memory device 50 of the present invention can completely achieve functions of the sequential multiple-byte reading protocol in a low-wire/low-pin count bus.

Accordingly, after sensor amplifiers of each output buffer 72 finish sensing/reading data corresponding to the address AR(X+2) between time points t8b and t9 (or the one-bit data Ax2 and Bx2 in signals SAOUT1 and SAOUT2), the address calculation module 60A also finishes calculating address AR(X+3). From time point t8b, the output buffer 72 can output the one-bit data Ax2 through the latch circuits 82A and 84 by high levels at time points t8m to t9, t9 to t9a, and t9a to t9b in turn based on the signals SASEL, OBLAT, and HNBSEL, and the other one-bit data Bx2 outputs in the next cycle T through the latch circuits 82B, 82A, and 84. From time points t9 to t9b and t10, the address buffer 60B and each sensor amplifier sense/read the address AR(X+3), and each latch circuit of each output buffer 72 just processes data output of the former address at the same time; however, the address calculation module 60A has already calculated the next address AR(X+4) at time point t10. Because each related module of the present invention works sequentially, the present invention can fit the sequential multiple-byte reading protocol, so as to promote efficiency of data exchange in a low-wire/low-pin count bus.

In comparison with the prior art, the present invention reads all eight bits corresponding to an address in each output buffer, and follows the sequential multiple-byte reading protocol to output the eight bits in turn by sequences of four bits, so that the former and later four bits of the same byte can output sequentially. Furthermore, the present invention processes data sensing and address calculations at the same time by address buffer modules and address calculation modules, so that data of different addresses can be sensed and read sequentially. Combining the above two mechanisms, the memory device of the present invention can achieve sequential multiple-byte reading to output data of different addresses sequentially, increasing data exchange efficiency and improving the function of a computer system.

Those skilled in the art will readily observe that numerous modifications and alterations of the device may be made while retaining the teachings of the invention. Accordingly, the above disclosure should be construed as limited only by the metes and bounds of the appended claims.

1. A memory device comprising:
a plurality of memory units each corresponding to an address for recording data;
an interface circuit for receiving address information;
an address calculation module connected to the interface circuit for providing a first address according to the address information;
an address buffer connected to the address calculation module for receiving and storing addresses provided by the address calculation module, wherein the address calculation module is capable of generating and providing a second address different from the first address according to the address information after the address buffer stores the first address; and
a decoding module connected to the address buffer for enabling each memory unit corresponding to the first address to output its data when the address buffer stores the first address, the address calculation module capable of providing the second address after each memory unit corresponding to the first address outputs its data, the address buffer being capable of storing the second address provided by the address calculation module, and the decoding module being capable of enabling each memory unit corresponding to the second address to output its data.

2. The memory device of claim 1 wherein at least two of the plurality of memory units are corresponding to the same address, and the memory device further comprises:
at least one output buffer each connected to each memory unit corresponding to the same address, when each memory unit corresponding to the same address synchronously outputs its data, the output buffer is capable of storing the output data provided by each memory unit and providing data as output of the memory device for each memory unit at different times in turn.

3. The memory device of claim 2 wherein the output buffer comprises:
a first and second latch circuit each respectively connected to different memory units corresponding to the same address for storing the data provided by each memory unit, the output buffer setting the data stored in the first latch circuit as the output of the memory device; and
a transmission circuit connected to the two latch circuits, when the memory units connected to the first latch circuit and the second latch circuit output data, the transmission circuit shuts down and enables the first and the second latch circuits to be capable of respectively storing data provided by two memory units; and when data stored in the first latch circuit was set for the output of the memory device by the output buffer, the transmission circuit turns on and transmits data stored in the second latch circuit to the first latch circuit and enables the output module to be capable of setting the data stored in the first latch circuit for the output of the memory device so that the output buffer is capable of providing data outputted from each memory unit at different times in turn.

4. The memory device of claim 3 wherein the transmission circuit is a transmission gate.

5. The memory device of claim 2 wherein the output buffer is further connected to the interface circuit and provides output data for each memory unit in turn through the bus of the interface circuit set for receiving the address information.

6. The memory device of claim 1 wherein the memory device is a non-volatile memory.

7. The memory device of claim 1 wherein the address calculation module calculates the second address by progressively increasing addresses from the first address.

8. The memory device of claim 1 wherein the plurality of memory units are arrayed in a matrix, and the decoding module comprises a column decoder and a row decoder.

9. A memory device comprising:
a plurality of memory units each corresponding to an address for recording data, wherein at least two memory units are corresponding to the same address;
a decoding module capable of receiving an address and enabling each memory unit corresponding to the address to output its data; and
at least one output buffer each connected to memory units corresponding to the same address, when the memory units corresponding to the same address output their data synchronously, the output buffer is capable of storing data provided by each memory unit and at different times providing data provided by each memory unit in turn for being output of the memory device.

10. The memory device of claim 9 wherein the output buffer comprises:
a first and second latch circuit each respectively connected to different memory units corresponding to the same address for storing the data provided by each memory unit, the output buffer setting the data stored in the first latch circuit as the output of the memory device; and
a transmission circuit connected to the two latch circuits, when the memory units connected to the first latch circuit and the second latch circuit output data, the transmission circuit shuts down and enables the first and the second latch circuits to be capable of respectively storing data provided by two memory units; and when data stored in the first latch circuit was set for the output of the memory device by the output buffer, the transmission circuit turns on and transmits data stored in the second latch circuit to the first latch circuit and enables the output module to be capable of setting the data stored in the first latch circuit for the output of the memory device so that the output buffer is capable of providing data outputted from each memory unit at different times in turn.

11. The memory device of claim 10 wherein the transmission circuit is a transmission gate.

12. The device of claim 9 comprises:
an interface circuit for receiving address information;
an address calculation module for providing a first address according to the address information;
an address buffer connected to the address calculation module for receiving and storing the first address provided by the address calculation module, wherein the address calculation module is capable of generating and providing a second address different from the first address according to the address information after the address buffer stores the first address; and
wherein the decoding module is connected to the address buffer for enabling each memory unit corresponding to the first address to output its data when the address buffer stores the first address, the address calculation module capable of providing the second address after each memory unit corresponding to the first address outputs its data, the address buffer being capable of storing the second address provided by the address calculation module, and the decoding module being capable of enabling each memory unit corresponding to the second address to output its data.

13. The memory device of claim 12 wherein the output buffer is further connected to the interface circuit and provides output data for each memory unit in turn through the bus of the interface circuit set for receiving the address information.

14. The memory device of claim 11 wherein the address calculation module calculates the second address by progressively increasing addresses from the first address.

15. The memory device of claim 9 wherein the memory device is a non-volatile memory.

16. The memory device of claim 9 wherein the plurality of memory units are arrayed in a matrix, and the decoding module comprises a column decoder and a row decoder.
